(19) United States
(12) Patent Application Publication
(10) Pub. No.: US 2002/0028363 A1
(43) Pub. Date: Mar. 7, 2002

(54) Method for operating a gas generation system

(76) Inventors: Stefan Boneberg, Beuren (DE); Oliver Freitag, Stuttgart (DE); Berthold Keppeler, Owen (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/912,419

(22) Filed: Jul. 26, 2001

(30) Foreign Application Priority Data
Jul. 26, 2000 (DE) 100 36 267.2-45

(51) Int. Cl. H01M 8/06; H01M 8/22; B60L 8/00; B60K 1/00

(52) U.S. Cl. 429/17; 429/20; 180/65.3

(57) ABSTRACT

A method is used for operating a gas generation system in a motor vehicle. A hydrogen-containing gas is generated in the gas generation system from a starting material which contains at least a proportion of liquid hydrocarbon as fuel. The hydrogen-containing gas is used to operate a fuel cell which provides the on-board power supply to the motor vehicle.

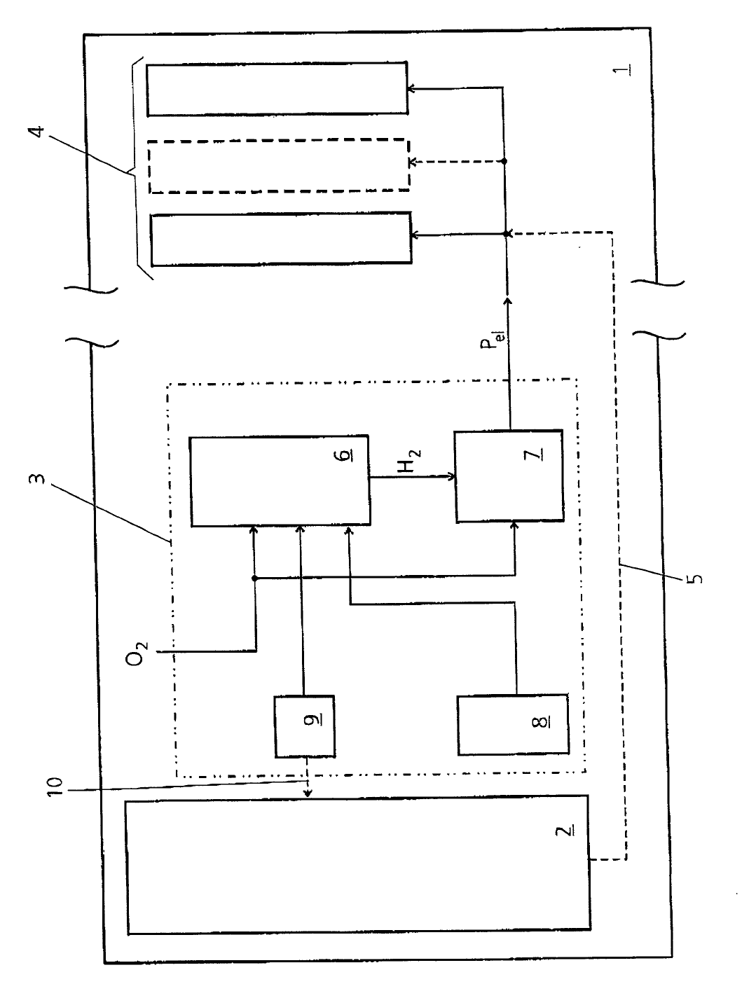

### BACKGROUND AND SUMMARY OF INVENTION

This application claims the priority of German application No. 100 36 267.2, filed Jul. 26, 2000, the disclosure of which is expressly incorporated by reference herein.

The present invention relates to a method for operating a gas generation system in a motor vehicle.

U.S. Pat. No. 4,820,594 discloses a method of starting a gas generation system in a fuel cell system. The thermal energy required for the gas generation system, in the starting phase, is produced by the fuel used in the system by direct combustion of this fuel in the region of at least individual components of the gas generation system. In the process, the fuel that is present in the fuel cell system and is reformed by the gas generation system to form the hydrogen-containing gas for the fuel cell during further operation of the system is used for this combustion for rapid heating of the gas generation system.

Although this method has advantages since only a single fuel has to be stored in the system, the corresponding use of the fuel cell system is restricted since it is generally necessary to use a fuel which is easy to reform and is relatively unfavourable in terms of its energy density for the combustion, and since it is necessary to hold a corresponding store of water for reforming of the fuel.

U.S. Pat. No. 5,110,559 likewise shows a gas generation system which is suitable for generating a hydrogen-containing gas for operating a fuel cell. The thermal energy which is required for reforming the starting material while the gas generation system is operating is fed to the reforming reactor by combustion of the gas which is generated.

This procedure has drawbacks during the starting phase, since during this phase there is as yet an insufficient quantity of hydrogen-containing gas available to ensure that the reformer is fired so as to generate the required thermal energy.

In gas generation systems for fuel cell systems which are operated with methanol as starting materials for the generation of the hydrogen-containing gas, in the starting phase, the methanol is converted on catalysts, since the entire gas generation system has not yet reached the temperature required for it to operate. However, this conversion of the methanol on the catalyst is also difficult, since the activity of the catalyst itself is only very low at the relatively low temperatures which generally prevail. Moreover, the methanol has to be evaporated in order to achieve the optimum distribution and at least approximately complete conversion on the corresponding catalyst.

DE 197 55 814 C1 discloses a method in which, during the cold start of the system, at least part of the reforming reactor, as a multifunctional reactor unit, is operated, in a first operating phase, as a catalytic burner unit with a fuel and an oxygen-containing gas being supplied. In a subsequent second operating phase, the at least one part of the reforming reactor is operated as a unit for the partial oxidation of the hydrocarbon and subsequently, once the system has warmed up, at least at times as a reformer unit for the steam reforming of the hydrocarbon.

With this method, it is possible to improve the starting properties of a gas generation system. However, similar drawbacks to those of the documents mentioned above apply, since in this case too the system is operated with the corresponding hydrocarbon, for example methanol, and since this hydrocarbon, for conversion in the first starting phase of the system has to be as pure as possible (i.e., it is no longer possible, for example, to fill up with a premix).

Therefore, it is an object of the present invention to provide a method for operating a gas generation system which generates a hydrogen-containing gas for operation of a fuel cell from a liquid starting material which contains at least a proportion of liquid hydrocarbon, so that its supply with thermal energy is as ideal as possible during all operating phases.

This object is achieved by a method according to the present invention.

The use of a corresponding additional fuel, such as for example natural gas, naphtha, dimethyl ether, petrol, diesel, liquefied gas or the like, leads to considerable advantages, in particular during the starting phase of the gas generation system.

The corresponding fuels which can be used may, for example, be relatively easy to evaporate and therefore simplify distribution of the fuel. Furthermore, the activation energy required to convert the fuel at the catalyst can be significantly reduced. This in turn simplifies and accelerates a cold start particularly at low temperatures. Moreover, fuels of this type can be converted virtually without residues by suitable thermal or catalytic conversion. As a result, and also on account of the rapid heating, the gas generation system can be operated with correspondingly lower starting emissions.

The fuel which is used may, for example, have a far higher calorific value than the fuel which is otherwise used for reforming in the gas generation system, so that the supply of thermal energy to individual components of the gas generation system, such as for example reformer, evaporator, shift stages or the like, can be improved.

A further advantage is that the additional fuel may have a far higher energy density than the fuel which is provided for operation of the gas generation system, for example methanol. This very high energy density results in considerable advantages with regard to the space which is required for storing the additional fuel. This is reflected in the additional length of lines required and the tank required for the additional fuel. Overall space and packaging advantages are achieved since the additional fuel which is used to generate the thermal energy requires a much smaller storage volume than a quantity of fuel which needs to be reformed, for example of methanol, required to provide the same level of thermal energy.

A further advantage is that with the method according to the present invention, it is possible to operate the gas generation system with a preproduced mixture of water and liquid hydrocarbon, known as a premix. This results in considerable advantages in particular with relatively small units comprising gas generation system and fuel cell which, in an embodiment of the present invention, can be used as auxiliary power unit in addition to a drive unit of the motor vehicle.

These auxiliary power units, also known as APU's, may then have a very simple structure, since the starting materials water and methanol for the gas generation are already present in the required volumetric ratio and conversion of this premix can be achieved with significantly lower outlay on components, for example pumps, and with much simpler components, for example, one-pass evaporators instead of a two-pass evaporator for separate evaporation of water and methanol.

In this embodiment of the present invention, further advantages result from the fact that the additional fuel which is also used for the drive unit can be used as the fuel in accordance with the present invention. This drive unit may, for example, be an internal combustion engine which is operated using a liquid hydrocarbon, such as, for example, petrol or diesel. This fuel, which is then already present in the motor vehicle, can therefore be used, according to the method of the present invention, as additional fuel, so that it is possible to make further savings in terms of space, storage units and the like.

One possible particular application for a structure which uses the method according to the present invention for operation of an APU is commercial vehicles. In this case, a supply of power is desired even when the drive unit is stationary, for example during breaks or at weekends when the drivers of the commercial vehicles are present in the commercial vehicle and require electrical energy to operate air-conditioning systems, audio and video equipment and the like. Furthermore, use in stationary air-conditioning or in commercial vehicles with an air-conditioning system, for example for cooling perishable freight, also plays a role.

A further highly expedient application may be used in mobile homes or the like. Vehicles of this type, in addition to the fuel for the drive unit of the vehicle, often additionally carry a further hydrocarbon, generally a liquefied gas for cooking, heating and if appropriate cooling. In this case, this liquefied gas could particularly expediently be used as a further fuel for the method according to the present invention for operation of the APU, since in this case it is very easy to supply and regulate the flow of further fuel into the gas generation system.

Other objects, advantages and novel features of the present invention will become apparent from the following detailed description of the invention when considered in conjunction with the accompanying drawings.

### BRIEF DESCRIPTION OF THE DRAWING

The single figure shows a schematic diagram of motor vehicle having an auxiliary power unit according to the present invention.

### DETAILED DESCRIPTION OF THE DRAWING

The figure shows a motor vehicle 1, with a drive unit 2, for example an internal-combustion engine. Moreover, the motor vehicle 1 has a unit 3 for supplying auxiliary power, known as an APU 3 (auxiliary power unit), as well as a number of electrical consumers 4. These electrical consumers 4 may, for example, be an air-conditioning system, audio and video equipment, or the like. However, auxiliary units of the drive unit 2, such as for example an electrically-driven water pump, a power-steering pump, elements of the engine electronics, or the like are other conceivable electrical consumers 4.

These electrical consumers 4 are supplied with electrical energy or electric power Pₑₗ from the APU 3. However, as indicated by the connection 5 shown in dashed lines, it is also possible for additional electrical energy or power to be derived from the drive unit 2, for example in a manner know per se from a generator which is driven directly or indirectly by a crank shaft of the drive unit 2.

The APU 3 comprises a gas generation system 6 which generates a hydrogen-containing gas (H₂) from an oxygen-containing gas (O₂), such as for example air, which is supplied, and a generally liquid hydrocarbon, a hydrocarbon mixture or a hydrocarbon/water mixture (premix), and makes this hydrogen-containing gas available to a fuel cell 7, in which its energy content, together with an oxygen-containing gas (O₂), in particular air, is converted into electrical energy. The starting material which is provided for the generation of the hydrogen-containing gas (H₂) in the gas generation system 6 is made available to the gas generation system 6 from a starting material storage device 8.

Particularly in the case of the APU 3, which generally has a relatively low rated electric power, it is recommended for the gas generation system 6 and the fuel cell 7 to be operated by a water/methanol mixture, known as a premix, as starting material. On account of the use of the premix as starting material, the gas generation system 6 or individual components in this gas generation system 6 may be of correspondingly simpler structure, since in this case there is no need for a separate treatment of water and methanol, thus reducing the length of lines and the complexity of the components used accordingly.

Since in an APU 3 of this type which represents a relatively small structural unit, supplying the gas generation system 6, in particular the heat exchanger and the reforming reactor, with the required thermal energy exclusively from the waste heat generated by the gas generation system 6 is relatively difficult, it is useful, for ideal operation, if this thermal energy which is additionally required can be provided via an additional fuel which is stored in a fuel-storage device 9.

In this case, the fuel-storage device 9 may be formed separately from the starting-material-storage device 8. This enables a fuel which differs from the starting material to be used as the fuel. This allows the use of the premix as starting material, with the associated simplifications, and allows the fuel which is stored in the fuel-storage unit 9 to have a higher calorific value and a higher energy density than the hydrocarbon fraction of the premix which is stored in the starting-material-storage device 8. In this way, it is possible to keep the required volume for the fuel-storage device 9 extremely small.

When using the same fuel as additional fuel for the gas generation system 6 and as fuel for the drive unit 2, for example the internal-combustion engine, the fuel-storage device 9 can, in a very simple way, simultaneously form the fuel-storage device 9 for the drive unit 2, as indicated in the figure by the optional connection 10. This allows a very compact structure of the APU 3, which then only requires the connection 10, for example a line element, if appropriate with a delivery device, to the fuel-storage device 9 which already exists.

Alternatively, when used in a mobile home, it would also be possible for a liquefied-gas store, which is customarily provided for appropriate applications, such as cooking or heating, to serve as the fuel-storage device 9, which then also supplies the gas generation system 6 of the APU 3 with the additional fuel. This results in very favourable possibilities with regard to the delivery and regulation of the volumetric flow of fuel, since this can be achieved particularly easily in a known way with liquefied gas.

In principle, there are in this case various possible ways of converting the fuel from the fuel-storage device 9 in the gas generation system 6. If a hydrocarbon which boils at a lower temperature than the starting material stored in the starting-material-storage device 8 is used as the fuel, it can be converted, for example, by the devices of the gas generation system 6, i.e. the catalysts, the reformers and the like, in a similar way to when using the starting material in the gas generation system 6.

An alternative which, however, may also be provided in addition to the use described above is the use of the additional fuel for generating the thermal energy in the form of conventional combustion which is known per se. For this conventional combustion, it is possible to use both a low-boiling fuel and another suitable fuel, such as for example diesel fuel when using the APU 3 in a commercial vehicle. Diesel fuel makes use of its favorable properties in terms of the high energy content for a relatively small storage volume.

In addition to this use of the method in an APU 3, use in a correspondingly larger fuel cell system with a similar gas generation system 6 is, of course, also quite possible. For an application of this type, the method may then be of rapid use in particular in a starting phase of the gas generation system 6, since in this case the gas generation system 6 can be heated very rapidly and readiness for operation can be reached very quickly. This then enables lower starting emissions of the overall system to be achieved.

In this context, a highly expedient application would be a mobile home which is operated exclusively by means of at least one fuel cell system and which is provided with an additional liquefied gas store which provides the energy for cooking and heating. This liquefied gas, as an additional fuel on board the vehicle 1, can then be used in a very simple way for the additional provision of the thermal energy for the gas generation system 6. In addition to being used purely in the starting phase, it is, of course, also conceivable for the method to be used for additional heating during operation should the operating conditions of the gas generation system 6 so demand.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a gas generation system in a motor vehicle, comprising:
generating a hydrogen-containing gas in a gas generation system from a starting material comprising a liquid hydrocarbon;
operating a fuel cell, thereby supplying on-board power to the motor vehicle; and
supplying thermal energy to the gas generation system via an additional fuel different from the liquid hydrocarbon at least in individual operating phases of the gas generation system.

2. A method according to claim 1, wherein the starting material is in liquid form.

3. A method according to claim 1, comprising operating a unit comprising the gas generation system and the fuel cell as a drive unit for the motor vehicle and also operating the unit as an auxiliary power unit for the motor vehicle.

4. A method according to claim 1, wherein the additional fuel has a higher energy density than that of the starting material.

5. A method according to claim 1, wherein the additional fuel has a boiling temperature that is lower than that of the starting material.

6. A method according to claim 1, further comprising converting the additional fuel in a similar manner to the starting material in the gas generation system.

7. A method according to claim 6, wherein the converting is by combustion in a region of individual components of the gas generation system.

8. A method according to claim 1, wherein a demand for electrical energy is independent of a driving state of the motor vehicle.

9. A method according to claim 1, wherein the starting material comprises a mixture of methanol and water.

10. A method according to claim 3, wherein the additional fuel is the fuel for operating the drive unit.

11. A method according to claim 1, wherein the additional fuel is selected from the group consisting of natural gas, naphtha, dimethyl ether, petrol, diesel, and liquefied gas.
